(19) United States
(12) Patent Application Publication
(10) Pub. No.: US 2016/0158113 A1
(43) Pub. Date: Jun. 9, 2016

(54) PACIFIER

(71) Applicant: OPRO MOTHER & BABY LTD., Raanana (IL)

(72) Inventor: Anthony LOVAT, Hertfordshire (GB)

(21) Appl. No.: 14/906,273

(22) PCT Filed: Aug. 1, 2014
(86) PCT No.: PCT/IB2014/063633

§ 371 Date: Jan. 20, 2016

(30) Foreign Application Priority Data
Aug. 1, 2013 (GB) 1313792.2

(51) Int. Cl. A61J 17/00

(52) U.S. Cl. CPC A61J 17/008

(57) ABSTRACT

The present invention provides a pacifier having a mouthpiece, a shield and an attachment. The shield defines an aperture and the mouthpiece and attachment are removeably connectable through the aperture thereby to hold the shield in place. Alternatively, the mouthpiece and shield may be connected in such a manner that they cannot be detached and reattached, and the shield and attachment are removeably connectable. Further alternatively, the mouthpiece and the shield are removeably connectable, and the shield and attachment are removeably connectable.

### FIELD OF INVENTION

The present invention relates to a pacifier for use in soothing babies and infants.

### BACKGROUND

Pacifiers are well known by parents for being used to sooth an infant or small child. An example of a pacifier 2 which is well known in the art is illustrated in FIG. 1. The pacifier 2 includes an elastomeric nipple 4, a shield 6 and a handle 8. The nipple 4, shield 6 and handle 8 are connected in such a way that they cannot be readily disconnected by the child to reduce the risk of choking. However, this has often meant that the nipple, shield 6 and handle 8 are permanently connected and cannot be readily detached from each other. For example, in EP2361600 the use of multiple different pacifiers having different sized nipples is described. One method of connecting the parts of a pacifier together is described in EP0153876 which describes a shield which is formed of two parts which have a snap lock means extending along their abutting rims which co-operate the two halves together in a tight and inseparable manner. The shield receives an edge bead of a teat part and includes a peg which is pressed into the open end of the teat part of the pacifier in order that the edge bead is locked in position by the shield. However, as with the pacifier described in EP2361600, once the parts of the pacifier are connected together they cannot be separated from the other without totally destroying the pacifier.

### SUMMARY OF THE INVENTION

According to a first aspect of the present invention there is provided a pacifier comprising a mouthpiece, a shield and an attachment wherein the shield defines an aperture and the mouthpiece and attachment are removeably connectable through the aperture thereby to hold the shield in place. This enables the shield to be locked in place between the mouthpiece, which may be a teat, nipple or any other suitable device to be inserted into the child's mouth and the attachment which may, for example, be a handle attachment.

According to a second aspect of the present invention there is provided a pacifier comprising a mouthpiece, a shield and an attachment wherein the mouthpiece and shield are connected in such a manner that they cannot be detached and reattached, and the shield and attachment are removeably connectable. This enables a user to interchange the attachment in order that, for example, different handle attachments can be used.

According to a third aspect of the present invention there is provided 5 a pacifier comprising a mouthpiece, a shield and an attachment wherein the mouthpiece and the shield are removeably connectable, and the shield and attachment are removeably connectable.

The mouthpiece may include a neck which extends back upon itself to receive a projecting wall which extends from a surface of the shield. The neck may be secured in place by an annular ring configured to be received by the projecting wall.

Alternatively, the shield may have a projecting wall which extends from a surface of the shield and the pacifier also includes a plug configured to be received within the projecting wall thereby to hold a neck of the mouthpiece in frictional engagement between the projecting wall and the plug.

The neck of the mouthpiece may include a thickened end portion sized to be compressed between an upper surface of the plug and an upper surface of the projecting wall.

The shield may be provided with an aperture through which the neck of the mouthpiece extends and the projecting wall is set back from the edge of the aperture. The neck of the mouthpiece has a thickened end portion sized to be received and rest upon the portion of shield between the aperture and the projecting wall. This means that when the plug is engaged with the shield the thickened end of the plug is compressed by the plug. Preferably the plug is provided with a projection which further compresses the thickened end. The attachment and shield may be provided with complementary screw threads to enable them to removeabley connect.

Optionally, one of the attachment and shield is provided with a projection and the other of the attachment and shield is provided with a complementary recess configured to removeably receive the projection. This allows the attachment and shield to be engaged in such a way that they cannot be readily disengaged by an infant or baby but can be disengaged by a parent or carer. The attachment may be provided with a base part and a side wall and the projection or recess may be provided on the inner surface of the side wall. The shield may be provided with a projecting wall with 5 the projection or recess being provided on the outer surface of the projecting wall.

Alternatively or additionally, the shield may be provided with a projecting wall with the projection or recess being provided on the inner surface of the projecting wall. The attachment is provided with a base part, a side wall and a inner projection from the base part configured to be received within the projecting wall of the shield, the projection or recess on the attachment is provided on the outer surface of the inner projection.

The projecting wall and inner projection may be configured to hold a neck of the mouthpiece in frictional engagement between them. The neck of the mouthpiece comprises a thickened end portion sized to be compressed between the attachment and an upper surface of the projecting wall.

The shield may be provided with an aperture through which the neck of the mouthpiece extends and the projecting wall may be set back from the edge of the aperture. The neck of the mouthpiece has a thickened end portion sized to be received and rest upon the portion of shield between the aperture and the projecting wall and be compressed by a projection from the plug.

### BRIEF DESCRIPTION OF THE DRAWINGS

FIG. 1 illustrates a known pacifier;

FIG. 2 illustrates a pacifier according to an embodiment of the present invention;

FIGS. 3a to 3j are cross sections illustrating different methods of removeably connecting a shield and attachment;

FIGS. 4a to 4e are cross sections illustrating different methods of removeably connecting a shield and mouthpiece;

FIGS. 5a to 5d are non-limiting examples of modular pacifiers; and

FIG. 6 illustrates a non-limiting example of the various modules that can be selected while preparing a customized pacifier.

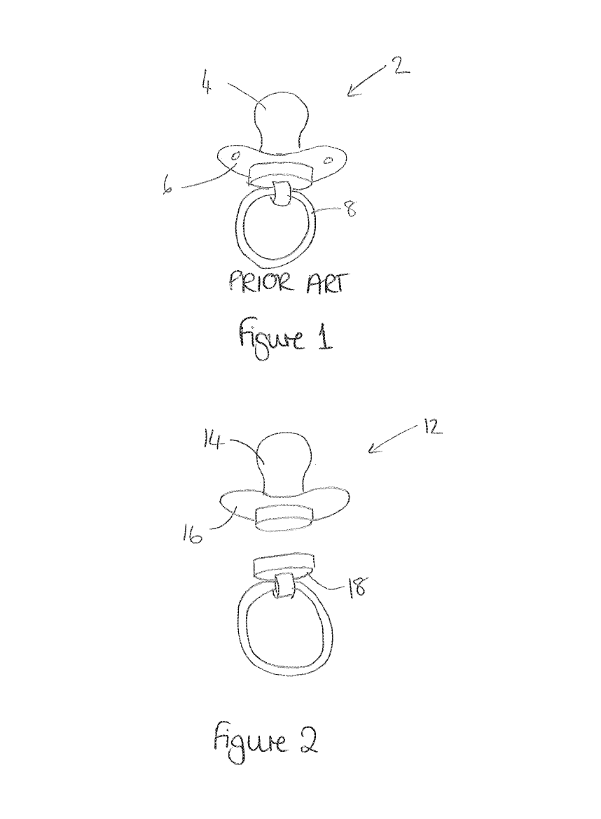

### DETAILED DESCRIPTION

According to one embodiment of the present invention a pacifier is provided where the mouthpiece and shield are attached in such a way that they cannot be detached from one another and then reattached. This may be, for example, using adhesive. The attachment portion of the pacifier is removeably connectable to 5 the shield. One example of such a pacifier 12 where the attachment portion 18 is detached from the shield 16 is illustrated in FIG. 2.

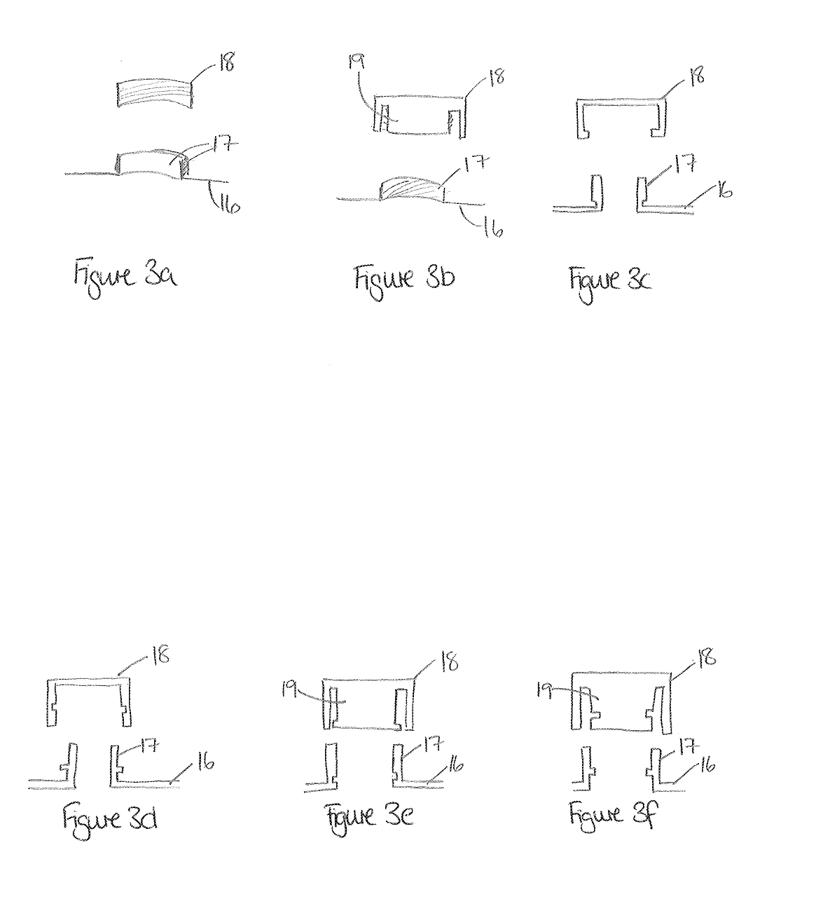

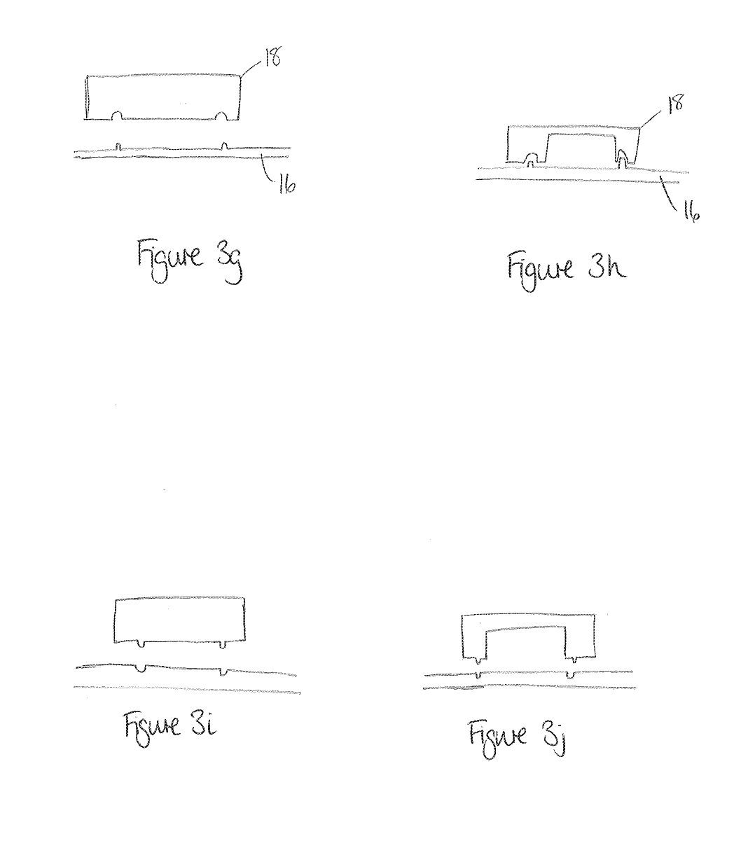

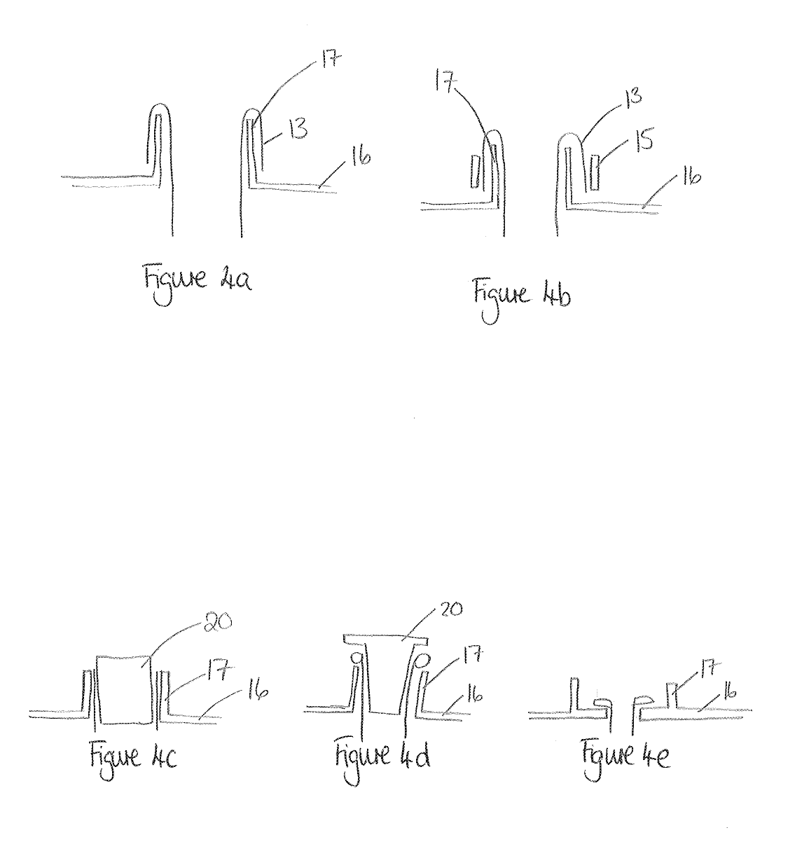

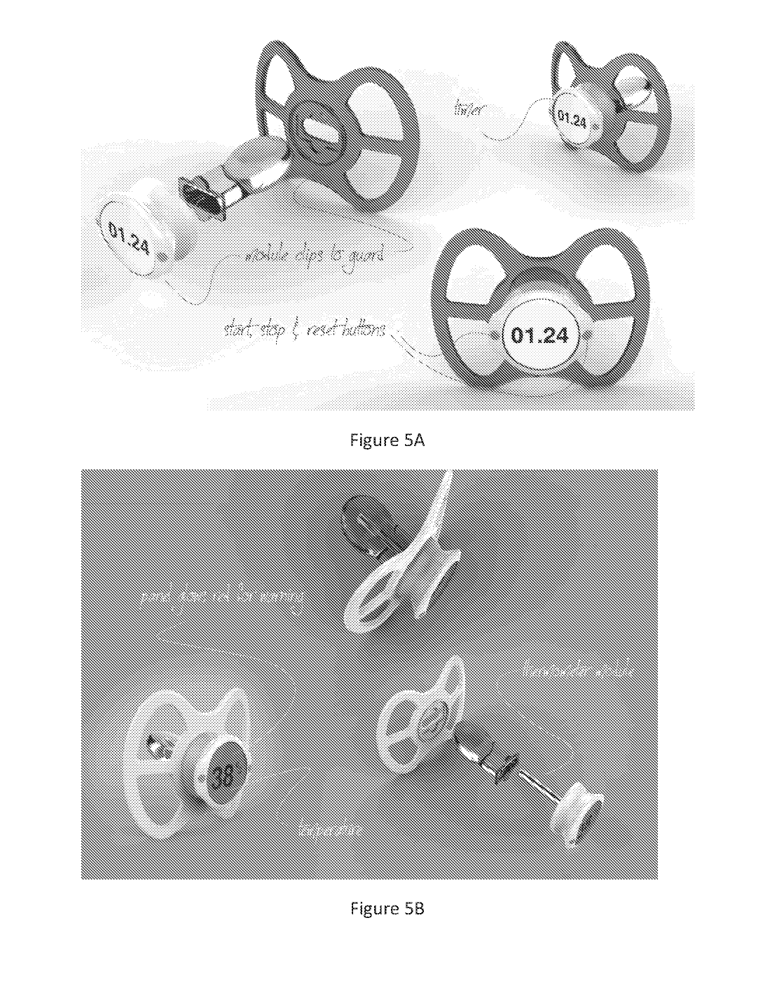

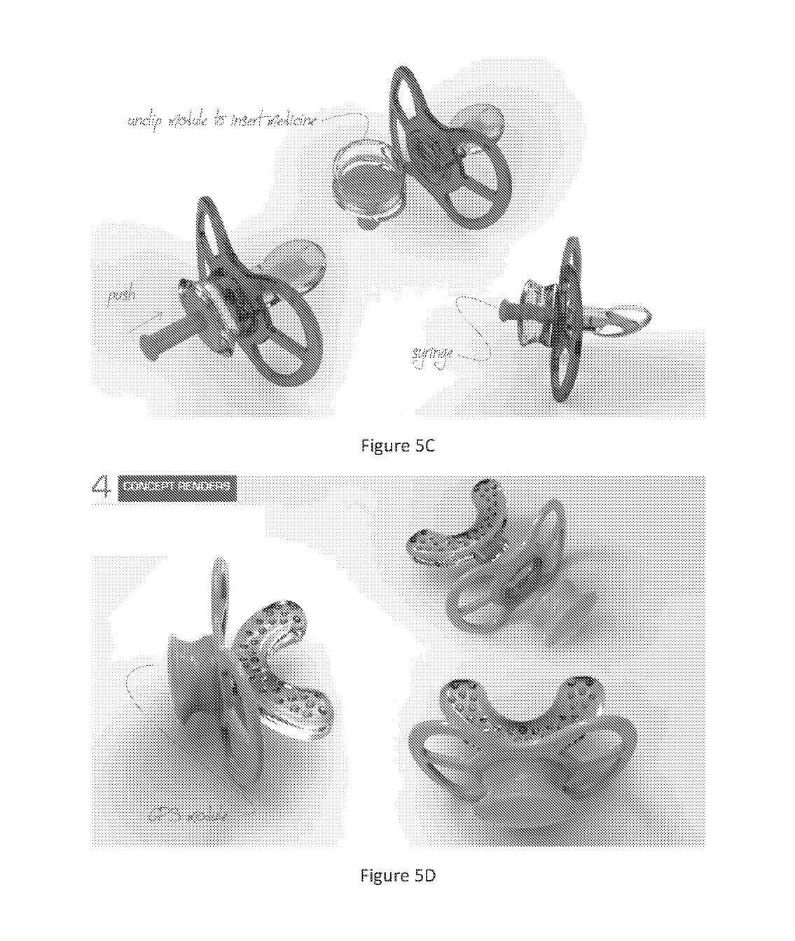

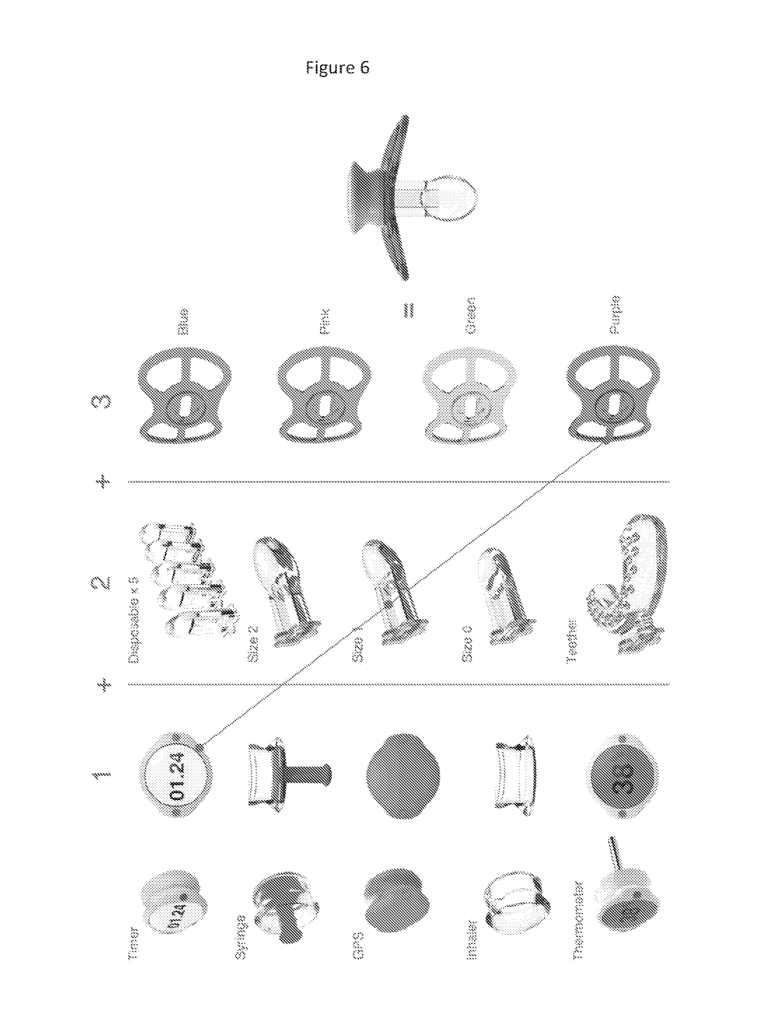

FIGS. 3a to 3j illustrate alternative methods which may be used to removeably connect the shield and attachment means.

In FIG. 3a the shield 16 includes a lip 17 having a screw thread on its outer surface. The attachment portion 18 has a base part and a side wall. The inside surface of the side wall is provided with a complementary screw thread to that present on the shield. In this way the attachment portion 18 can be screwed onto the shield 16.

In FIG. 3b the shield 16 includes a lip 17 having a screw thread on its inner surface. The attachment portion 18 has a base part and a side wall. The attachment portion also has an inner projection 19 which may or may not be hollow. The outer surface of the inner projection is provided with a complementary screw thread to that present on the shield 16. In this way the attachment portion 18 can be screwed onto the shield 16.

In FIG. 3c the shield 16 includes a lip 17 and an annular recess formed around the circumference of the outer surface lip 17 where it meets the flat portion of the shield 16. The attachment portion 18 has a base part and a side wall. The end of the side wall is provided with a projection shaped to be received by the recess present on the shield 16. In this way the attachment portion 18 will be held in connection with the shield 16.

The attachment portion may be provided with levers or alternative means to facilitate removal of the attachment portion from the shield. It will also be understood that the projection and recess may not extend around the entire circumference of the side wall and lip respectively but one or more projections and recesses may be provided which only extend partially around the circumference of the side wall and lip respectively.

In FIG. 3d the shield 16 includes a lip 17 and an annular projection formed around the circumference on the outer surface of the lip at a distance from where the lip meets the flat portion of the shield 16. The attachment portion 18 has a base part and a side wall. The side wall is provided with a recess positioned and shaped to receive the projection present on the shield 16. In this way the attachment portion 5 18 will be held in connection with the shield 16.

The attachment portion may be provided with levers or alternative means to facilitate removal of the attachment portion from the shield. It will also be understood that the projection and recess may not extend around the entire circumference of the lip and side wall respectively but one or more projections and recesses may be provided which only extend partially around the circumference of the lip and side wall respectively.

In FIG. 3e the shield 16 includes a lip 17 and an annular recess formed around the circumference of the inner surface of the lip 17. The attachment portion 18 has a base part and a side wall. The attachment portion also has an inner projection 19 which may or may not be hollow. The outer surface of the inner projection 19 is provided with a projection shaped to be received by the recess present on the shield 16. In this way the attachment portion 18 will be held in connection with the shield 16.

The attachment portion may be provided with levers or alternative means to facilitate removal of the attachment portion from the shield. It will also be understood that the projection and recess may not extend around the entire circumference of the side wall and lip respectively but one or more projections and recesses may be provided which only extend partially around the circumference of the side wall and lip respectively.

In FIG. 3f the shield 16 includes a lip 17 and an annular projection formed around the circumference of the inner surface of the lip 17. The attachment portion 18 has a base part and a side wall. The attachment portion also has an inner projection 19 which may or may not be hollow. The outer surface of the inner projection 19 is provided with a recess shaped to be received by the projection present on the shield 16. In this way the attachment portion 18 will be held in connection with the shield 16.

The attachment portion may be provided with levers or alternative means to facilitate removal of the attachment portion from the shield. It will also be understood that the projection and recess may not extend around the entire circumference of the lip and side wall respectively but one or more projections and recesses may be provided which only extend partially around the circumference of the lip and side wall respectively.

In FIGS. 3g and 3h the shield 16 includes a projection which extends from a surface of the shield. The attachment portion 18 is either formed of a single solid portion as illustrated in FIG. 3g or may have a base part and a side wall as illustrated in 3h.

The attachment portion has a recess in the end of the side wall or portion of the base part to be in connection with the shield. The projection and recess have corresponding shapes and positions in order that they hold each other in frictional engagement. In this way the attachment portion 18 will be held in connection with the shield 16.

In FIGS. 3i and 3j the shield 16 includes a recess positioned in a surface of the shield. The attachment portion 18 is either formed of a single solid portion as illustrated in FIG. 3i or may have a base part and a side wall as illustrated in 3j. The attachment portion has a projection from the end of the side wall or portion of the base part to be in connection with the shield. The projection and recess have corresponding shapes and positions in order that they hold each other in frictional engagement. In this way the attachment portion 18 will be held in connection with the shield 16.

The attachment portion of FIGS. 3g to 3j may be provided with levers or alternative means to facilitate removal of the attachment portion from the shield. It will also be understood that the projection and recess may have any suitable shape, for example they may form an annular ring or be single extensions distributed along the surface of the shield/attachment.

According to another embodiment of the present invention the mouthpiece and shield are removeably connectable in addition to the shield and the attachment being removeably connectable. Methods of removably connecting the shield and attachment are described with reference to FIGS. 3a to 3f above and will not be discussed further with reference to this embodiment.

FIGS. 4a to 4e illustrate alternative methods which may be used to removeably connect the shield and mouthpiece.

In FIG. 4a the mouthpiece is provided with neck that double backs upon itself to form an overhang 13. The overhang 13 of the neck is arranged to receive a lip 17 of the shield. Optionally, as illustrated in FIG. 4b the pacifier may be further provided with an annular ring 15 which can be placed over the overhang to hold it in place. The annular ring may or may not be a split annular ring and may be made of any suitable material. The annular ring may additionally be provided with a projection or recess in order to receive a corresponding projection or recess present on the lip of the shield in a similar manner to that discussed with reference to FIGS. 3c and 3d.

Alternatively, rather than using an annular ring as illustrated in FIG. 4b an attachment, such as that described with reference to FIGS. 3c and 3d may be used to provide additional security to the connection between the mouthpiece and the shield.

In FIG. 4c the shield includes a lip 17 surrounding an aperture through which a neck of the mouthpiece projects. The pacifier is also provided with a plug 20 which can be inserted into the neck of the mouthpiece in order to hold it in frictional engagement with the lip 17 of the shield 16. Optionally the lip 17 and plug 20 may be provided with one or more corresponding projections and recesses which engage with each other in a similar manner to that discussed with reference to FIGS. 3e and 3f.

Alternatively, rather than using a plug as illustrated in FIG. 4c an attachment, such as that described with reference to FIGS. 3e and 3f may be used to provide additional security to the connection between the mouthpiece and the shield.

In FIG. 4d the neck of the mouthpiece ends with a thickened portion. The plug 20 of FIG. 4c is provided with a ledge around its upper circumference which compresses the thickened portion of the mouthpiece between itself and the upper end of the lip.

Such compression may also be provided by using an attachment such as that described with reference to FIGS. 3e and 3f where the compression is provided between the portion of the attachment joining the inner projection 19 and the attachment portion side wall. Alternatively, the compression may be provided using an attachment such as that described with reference to FIGS. 3c and 3d where the compression is provided between the end wall of the attachment portion and the upper end of the lip.

In FIG. 4e the lip of the shield is set back from the edge of an aperture through the shield. The neck of the mouthpiece extends through the aperture 5 and includes a thickened portion. Such a configuration allows the mouthpiece to be held in place by a plug, such as that illustrated in FIG. 3c or any one of the attachment means as described with reference to FIGS. 3b, 3e and 3f where the thickened portion of the mouthpiece is held in compression by the end of the inner projection 3 and the shield.

The skilled person will understand that the method of interconnecting the different parts of the pacifier are provided by way of example only and any suitable method of interconnecting the parts of the pacifier may be used.

The attachment portion may be any suitable part for attachment to a pacifier. It may include, for example, a handle such as that illustrated in FIG. 2 or alternatively, a timer such as that described and illustrated in the UK Patent Application filed by the applicant of the present application on 1 Aug. 2013 entitled “A Pacifier” and incorporated herein by reference. The mouthpiece may be any suitable mouthpiece, for example it may be a rubber or latex nipple or an orthodontic insert.

1. The pacifier of claim 20, wherein the shield defines an aperture and wherein the mouthpiece and the attachment are removably connected through the aperture and configured to hold the shield in place.

2. The pacifier of claim 20, wherein the mouthpiece and the shield are connected in such a manner that they cannot be detached and reattached, and wherein the shield and the attachment are removeably connected.

3. The pacifier of claim 20, wherein the mouthpiece and the shield are removably connected, and wherein the shield and the attachment are removably connected.

4. The pacifier of claim 20, wherein the mouthpiece includes a neck which extends back upon itself to receive a projecting wall which extends from a surface of the shield.

5. The pacifier of claim 4, further comprising an annular ring configured to be received by the projecting wall to secure the neck between the annular ring and the projecting wall.

6. The pacifier of claim 20 wherein the shield comprises a projecting wall which extends from a surface of the shield and further comprising a plug configured to be received within the projecting wall to hold a neck of the mouthpiece in frictional engagement between the projecting wall and the plug.

7. The pacifier of claim 6, wherein the neck of the mouthpiece comprises a thickened end portion sized configured to be compressed between an upper surface of the plug and an upper surface of the projecting wall.

8. The pacifier of claim 6, wherein the neck of the mouthpiece extends through the aperture defined by the shield and the projecting wall is set back from the edge of the aperture, the neck of the mouthpiece comprising a thickened end portion sized configured to be received by a portion of the shield which is between the aperture and the projecting wall and to be compressed by a projection from the plug.

9. The pacifier of claim 3, wherein the attachment and the shield comprise complementary screw threads configured to form the removable connection.

10. The pacifier of claim 3, wherein one of the attachment and the shield comprises a projection and wherein the other of the attachment and the shield comprises a complementary recess configured to removably receive the projection.

11. The pacifier of claim 10, wherein the attachment comprises a base part and a side wall with the projection or the recess being on an inner surface of the side wall, and wherein the shield comprises a projecting wall with the projection or recess being on an outer surface of the projecting wall.

12. The pacifier of claim 10, wherein the shield comprises a projecting wall with the projection or recess on an inner surface of the projecting wall and wherein the attachment comprises a base part, a side wall with an inner projection from the base part configured to be received within the projecting wall of the shield, wherein the projection or the recess on the attachment is provided on an outer surface of the inner projection.

13. The pacifier of claim 12, wherein the projecting wall and the inner projection are configured to hold a neck of the mouthpiece in frictional engagement between them.

14. The pacifier of claim 13, wherein the neck of the mouthpiece comprises a thickened end portion sized to be compressed between the attachment and an upper surface of the projecting wall.

15. The pacifier of claim 13, wherein the shield comprises an aperture through which the neck of the mouthpiece extends and the projecting wall is set back from the edge of the aperture, the neck of the mouthpiece comprising a thickened end portion sized to be received by the portion of shield between the aperture and the projecting wall and be compressed by a projection from the plug.

16-19. (canceled)

20. A pacifier comprising a mouthpiece, a shield and an attachment, wherein the attachment is removably connected to at least one of the shield and the mouthpiece.

21. The pacifier of claim 20, wherein the attachment comprises a handle.

22. The pacifier of claim 20, wherein the attachment comprises a timer.
